(19) United States
(12) Patent Application Publication
(10) Pub. No.: US 2003/0108156 A1
(43) Pub. Date: Jun. 12, 2003

(54) Communication system, communication method, action execution apparatus, and program in action execution apparatus

(75) Inventors: Kaoru Komaki, Tokyo (JP); Shinichi Takahashi, Tokyo (JP)

Correspondence Address: McGinn & Gibb, PLLC, Suite 200, 8321 Old Courthouse Road, Vienna, VA, 22182-3817, US

(73) Assignee: NEC Corporation, Tokyo (JP)

(21) Appl. No.: 10/308,142

(22) Filed: Dec. 3, 2002

(30) Foreign Application Priority Data
Dec. 7, 2001 (JP) 375066/2001

(51) Int. Cl. H04M 1/64

(52) U.S. Cl. 379/67.1; 379/88.22

(57) ABSTRACT

The present invention relates to a communication system/method including a message export section/step of exporting a message to a user terminal through a communication network on the basis of a preset export condition, a reply confirming section/step of receiving from the user terminal through the communication network a reply to the message exported by the message export section/step, and confirming the reply, and an action executing section/step of executing a preset action when no reply is confirmed by the reply confirming section/step. In the communication system/method, the user terminal and an action execution apparatus which executes the steps are connected through the communication network.

### BACKGROUND OF THE INVENTION

1. Field of the Invention

The present invention relates to a communication system, communication method, action execution apparatus, and program in the action execution apparatus, which execute user's desired action (a preset action for, e.g., delivering a message for a contact terminal that can contact the user) for a user who cannot reply to a message addressed to him/her.

2. Description of the Prior Art

Conventionally, when a user may become unable to execute his/her desired action due to some reason, he/she asks the family, relatives, or colleagues in advance to execute the desired action for the user.

For example, assume that a user will attend a meeting from 10:00 to 10:30 a.m. and also receive a call from a customer during that time. If the user attends the meeting, he/she cannot answer the phone. In this case, normally, the user asks in advance a person who will probably receive the telephone call to give the customer a message (do an action) “he/she should call you after the meeting” or “he/she should call you back after 10:30 a.m.” when the customer has actually called during the meeting.

As another prior art, a system which executes user's desired action on the basis of information such as an e-mail address or telephone number is known. In this system, the e-mail addresses or telephone numbers of persons who may originate mail messages or calls to the user's terminal (PC terminal, portable terminal, telephone set, or the like) are stored in advance. In addition, mail data or voice message is stored in correspondence with each e-mail address or telephone number in advance.

In this system, for example, when the user's terminal has received mail, the mail address of the originator is extracted. It is determined whether the mail address is present in the preset e-mail address list. If the mail address is present in the list, mail data that is stored in correspondence with the mail address is transmitted to the mail originator.

In the above method of asking someone for the desired action, when the user's schedule is clearly known, he/she can ask a third party for it. However, if the schedule readily changes or is unknown, the user cannot ask the third party for his/her desired action. Hence, the action cannot be executed.

In the conventional system described above, mail data or voice message stored in correspondence with a mail address/telephone number is delivered or exported by a result obtained by determining coincidence with the originator's mail address/telephone number which is stored in the user's terminal at the time of receipt/call terminating. That is, an action for the originator or caller is executed. This means that unless the user's terminal receives mail or a call, the preset action such as mail data delivery or voice message export cannot be executed because the trigger is uncertain.

### SUMMARY OF THE INVENTION

The present invention has been made in consideration of the above-described situations in the prior art, and has as its object to provide a communication system, communication method, action execution apparatus, and program in the action execution apparatus, which make it possible to recognize that user' situation does not allow an actual action, and to execute a preset action.

In order to achieve the above object, according to the first main aspect of the present invention, there is provided a communication system comprising message export means for exporting a message to a user terminal through a communication network on the basis of a preset export condition, reply confirming means for receiving from the user terminal through the communication network a reply to the message exported by the message export means, and confirming the reply, and action executing means for executing a preset action when the reply confirming means confirms no reply.

The communication system according to the first main aspect further comprises user setting information storage means for storing user setting information containing an address of the user terminal, the export condition, and the action, and the message export means and the action executing means can execute respective functions on the basis of the user setting information stored in the user setting information storage means.

In order to achieve the above object, according to the second main aspect of the present invention, there is provided a communication system comprising an action execution apparatus, the action execution apparatus comprising a message export section which exports a message to a user terminal through a communication network on the basis of a preset export condition, a reply confirming section which receives from the user terminal through the communication network a reply to the message exported by the message export section, and confirms the reply, and an action executing section which executes a preset action when the reply confirming section confirms no reply, wherein the user terminal and the action execution apparatus are connected through the communication network.

In the communication system according to the second main aspect, the action execution apparatus further comprises a user setting information storage section which stores user setting information containing an address of the user terminal, the export condition, and the action, and the message export section and the action executing section can execute respective functions on the basis of the user setting information stored in the user setting information storage section.

In order to achieve the above object, according to the third main aspect of the present invention, there is provided a communication method comprising the message export step of exporting a message to a user terminal through a communication network on the basis of a preset export condition, the reply confirming step of receiving from the user terminal through the communication network a reply to the message exported in the message export step, and confirming the reply, and the action executing step of executing a preset action when no reply is confirmed in the reply confirming step.

The communication method according to the third main aspect further comprises the user setting information storage step of storing user setting information containing an address of the user terminal, the export condition, and the action, and in the message export step and the action executing step, respective processes can be executed on the basis of the user setting information stored in the user setting information storage step.

In order to achieve the above object, according to the fourth main aspect of the present invention, there is provided a communication method in a communication system in which a user terminal is connected to an action execution apparatus through a communication network, comprising causing the action execution apparatus to execute the message export step of exporting a message to the user terminal through the communication network on the basis of a preset export condition, the reply confirming step of receiving from the user terminal through the communication network a reply to the message exported in the message export step, and confirming the reply, and the action executing step of executing a preset action when no reply is confirmed in the reply confirming step.

In the communication method according to the fourth main aspect, the action execution apparatus further executes the user setting information storage step of storing user setting information containing an address of the user terminal, the export condition, and the action, and in the message export step and the action executing step, respective processes can be executed on the basis of the user setting information stored in the user setting information storage step.

In order to achieve the above object, according to the fifth main aspect of the present invention, there is provided an action execution apparatus connected to a user terminal through a communication network, comprising message export means for exporting a message to the user terminal through the communication network on the basis of a preset export condition, reply confirming means for receiving from the user terminal through the communication network a reply to the message exported by the message export means, and confirming the reply, and action executing means for executing a preset action when the reply confirming means confirms no reply.

The action execution apparatus according to the fifth main aspect further comprises user setting information storage means, for storing user setting information containing an address of the user terminal, the export condition, and the action, and the message export means and the action executing means can execute respective functions on the basis of the user setting information stored in the user setting information storage means.

In order to achieve the above object, according to the sixth main aspect of the present invention, there is provided a program used in a communication system formed by connecting a user terminal to an action execution apparatus through a communication network, the program causing the action execution apparatus to execute a message export process for exporting a message to the user terminal through the communication network on the basis of a preset export condition, a reply confirming process for receiving from the user terminal through the communication network a reply to the message exported by the message export process, and confirming the reply, and an action executing process for executing a preset action when no reply is confirmed by the reply confirming process.

In the program according to the sixth main aspect, the action execution apparatus further executes a user setting information storage process for storing user setting information containing an address of the user terminal, the export condition, and the action, and in the message export process and the action executing process, respective processes can be executed on the basis of the user setting information stored by the user setting information storage process.

As is apparent from the above aspects, according to the present invention, even when a user cannot execute a desired action due to some reason, the action execution apparatus can confirm the user's situation and execute, for the user, the desired action set by the user himself/herself.

The above and many other objects, features and advantages of the present invention will become manifest to those skilled in the art upon making reference to the following detailed description and accompanying drawings in which preferred embodiments incorporating the principle of the present invention are shown by way of illustrative examples.

### BRIEF DESCRIPTION OF THE DRAWINGS

FIG. 1 is a block diagram showing the schematic arrangement of a communication system according to the first embodiment of the present invention;

FIG. 2 is a table showing user setting information;

FIG. 3 is a sequence chart showing processing in the first embodiment of the present invention;

FIG. 4 is a block diagram showing the first setting example of the user setting information in the first embodiment of the present invention;

FIG. 5 is a block diagram showing the second setting example of the user setting information in the first embodiment of the present invention;

FIG. 6 is a block diagram showing the third setting example of the user setting information in the first embodiment of the present invention;

FIG. 7 is a block diagram showing the schematic arrangement of a communication system according to the second embodiment of the present invention; and

FIGS. 8 to 11 are flow charts showing the first to fourth detailed operation examples in executing an action in the communication system of the present invention.

### DETAILED DESCRIPTION OF THE PREFERRED EMBODIMENTS

Preferred embodiments of a communication system, communication method, action execution apparatus, and program in the action execution apparatus according to the present invention will be described below in detail with reference to the accompanying drawings.

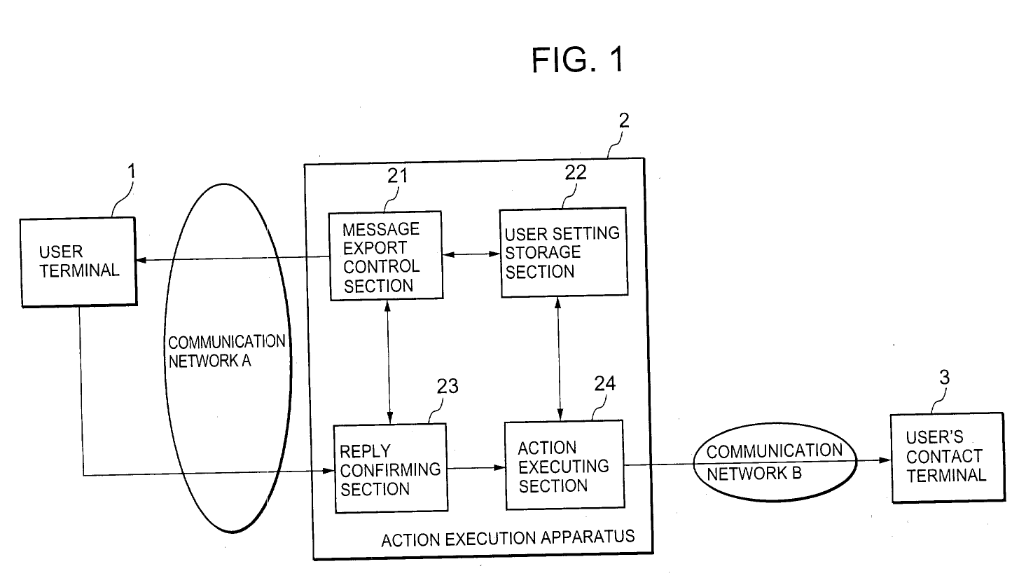

Referring to FIG. 1, a communication system according to the first embodiment of the present invention has a user terminal 1, action execution apparatus 2, and user's contact terminal 3. FIG. 1 shows an arrangement in which another terminal (contact terminal 3) that executes an action is connected to the action execution apparatus 2 through a communication network. More specifically, the user terminal 1 and action execution apparatus 2 are connected through a communication network A. The action execution apparatus 2 and contact terminal 3 are connected through a communication network B. The communication networks A and B may be a single communication network or separate communication networks. The communication networks can take various wired or wireless forms including a public switched telephone network, LAN network, cable network, connection by a dedicated line, and direct connection via cables. The contact terminal 3 is illustrated as another terminal connected to the action execution apparatus 2 through a communication network. However, the action execution apparatus 2 itself may serve as the contact terminal for which an action should be executed.

The user terminal 1 has a communication function. With this function, when a message is submitted from the action execution apparatus 2 to the user terminal 1 through the communication network A, and the user can reply to the message, the user terminal 1 transmits a reply (reply signal) to the action execution apparatus 2 through the communication network A. The data form of a message submitted from the action execution apparatus 2 is not particularly limited. Various data forms such as mail and voice messages can be employed.

When the user terminal 1 is to transmit a reply signal representing a reply to the message from the action execution apparatus 2, the user himself/herself may input a reply instruction using operation buttons prepared on the user terminal 1. When operation is programmed in advance such that if a message having a mail format is received, a reply signal may be transmitted when the user “has read” the received mail, or if a voice message is received, a reply signal may be transmitted when the voice message has been played back, the reply signal can be transmitted without direct button operation by the user.

The action execution apparatus 2 has, as functional sections, a message export control section 21, user setting storage section 22, reply confirming section 23, and action executing section 24. The user terminal 1 and contact terminal 3 also have communication functions so that they are connected to the action execution apparatus 2 through the communication network A and/or communication network B.

The message export control section 21 submits a message to the user terminal 1 on the basis of a user terminal address and message export condition in user setting information sent from the user setting storage section 22. At this time, the message export control section 21 notifies the reply confirming section 23 of information containing the address (user terminal address) of the user terminal 1 and the message export time. The message is arbitrarily designated by the user as part of the user setting information and submitted when the user terminal address and message export condition are sent to the message export control section 21. With this arrangement, user's desired message can be delivered.

The message export control section 21 has a function (e.g., a timer function) of realizing message submission based on the message export condition. For example, when “after 3 hrs from current time” is set as a message export condition, the timer function counts 3 hrs after the submission timing is determined on the basis of the message export condition. The period countable by the timer function is not particularly limited. For example, not hours but a long period such as “three months”, “half year”, or “one year” or a date/time such as “at 1:00 p.m. on March 1” may be set.

In the user setting storage section 22, user setting information such as user names (U1 to Un), user terminal addresses (A1 to An), message export conditions (B1 to Bn), and actions (C1 to Cn) are stored in correspondence with the respective users. The user setting information setting method will be described later.

The reply confirming section 23 confirms the reply from the user terminal 1 to the message exported from the message export control section 21 by receiving the reply through the communication network A. The reply confirming section 23 is notified by the message export control section 21 of the address of the user terminal 1 and the message export time. The reply confirming section 23 has a timer which starts counting time when a message is exported. This timer counts the elapse time until a reply signal is confirmed.

The reply confirming section 23 notifies the message export control section 21 of the presence or absence of a reply signal from the user terminal 1. If no reply signal is sent within a predetermined time, the reply confirming section 23 notifies the action executing section 24 of it. The predetermined time may be arbitrarily set by the user when he/she registers user setting information. Alternatively, the time may be arbitrarily set on the system manager side.

When notified of the absence of a reply signal by the reply confirming section 23, the action executing section 24 acquires a desired action from the user setting information stored in the user setting storage section 22 and executes the action. The action is not particularly limited and can take various forms such as exporting mail data or voice message to an address, video data delivery, or processing executed by the action execution apparatus 2 itself, which is set in the user setting storage section 22 as a desired action.

The contact terminal 3 needs only to be a device which has a communication function capable of receiving user's desired action (action based on electronic information) through the communication network. For example, a cellular phone, stationary telephone, FAX apparatus, PC terminal, or PDA terminal can be used. The contact terminal 3 is not limited to these communication terminals and may be an apparatus, program, or function for executing an action.

The above-described action execution apparatus 2 has a control section (CPU), a storage section (ROM or the like) which stores an operation program, and a work area (RAM) used to load and activate the operation program, through the section are not illustrated.

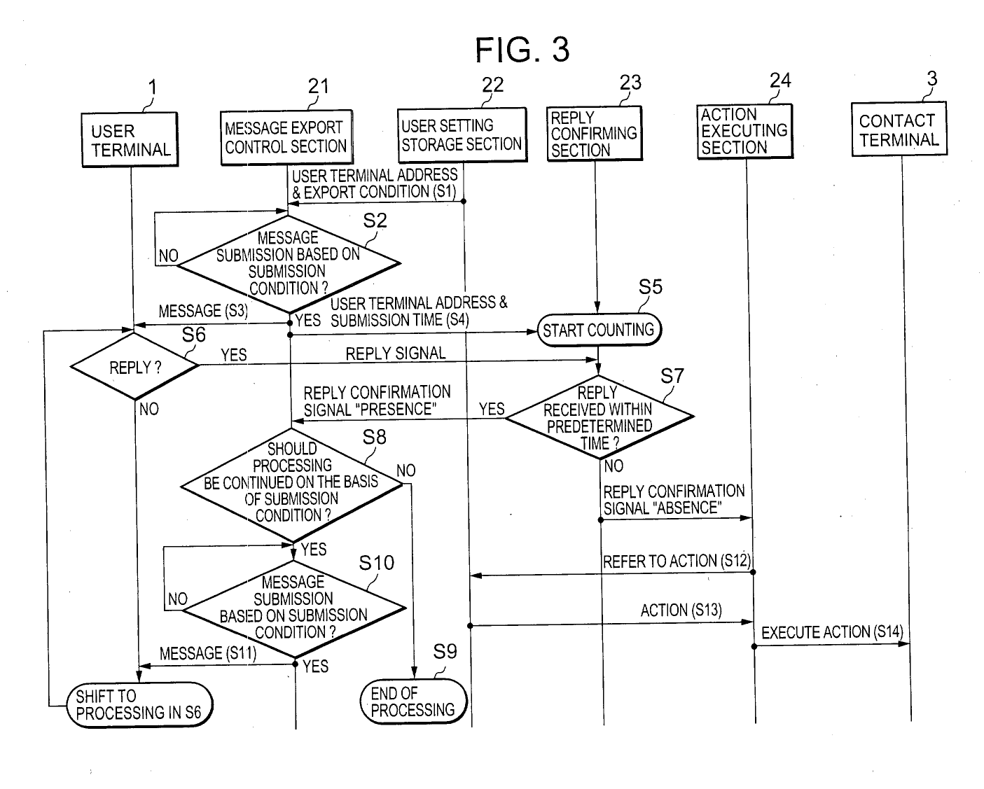

The processing sequence of the first embodiment will be described in relation to the processing sequence chart shown in FIG. 3. Referring to FIG. 3, the user setting information stored in the user setting storage section 22 is set in advance by the user himself/herself or a person who executes the setting on him/her.

First, the user setting storage section 22 transmits a user terminal address and message export condition to the message export control section 21 (step S1). At this time, message information that is arbitrarily set may be submitted as user setting information.

The message export control section 21 confirms the contents of the message export condition transmitted from the user setting storage section 22. The message export control section 21 determines on the basis of the export condition whether a message is to be submitted to the user terminal address (user terminal 1) transmitted from the user setting storage section 22 (step S2).

If it is determined on the basis of the message export condition that a message is to be submitted (YES in step S2), the message export control section 21 submits a message to the user terminal 1 (step S3). If it is determined that no message is to be submitted (NO in step S2), the processing is step S2 is repeated until message submission based on the message export condition is done.

The message export control section 21 submits a message to the user terminal 1 and then notifies the reply confirming section 23 of the address information of the user terminal 1 and the message submission time (step S4).

Upon receiving the user terminal address and message submission time from the message export control section 21 (step S4), the reply confirming section 23 counts, by the timer function, time until a reply signal from the user terminal 1 is confirmed or until a preset predetermined time using the notification of the submission time as a trigger (step S5).

When a message is submitted from the user setting storage section 22 (step S3), and the user can reply to the message, the user terminal 1 transmits to the reply confirming section 23 a predetermined reply signal executed by the user (YES in step S6).

The reply confirming section 23 monitors whether the reply signal from the user terminal 1 is confirmed within a predetermined time (step S7). When YES in step S7, a replay confirmation signal “presence” is sent to the message export control section 21 (step S8). If NO in step S7, and the time counted by the timer function has reached a predetermined time, reply confirmation signal “absence” is sent to the action executing section 24 (NO in step S7).

(a) Processing for Reply Confirmation Signal “Presence” in Step S7:

Upon receiving the reply confirmation signal “presence” from the reply confirming section 23, the message export control section 21 determines again on the basis of the message export condition transmitted from the user setting storage section 22 in step S1 whether the processing should be continued (step S8). If the processing should not be continued (NO in step S8), the processing is ended (step S9). If the processing should be continued (YES in step S8), it is determined on the basis of the message export condition whether a message is to be submitted (step S10). If a message is to be submitted (YES in step S10), a message is submitted to the user terminal 1 (step S11) If it is determined in step S10 that no message is to be submitted (NO in step S10), the processing in step S10 is continued until message submission based on the message export condition is executed.

When a message is submitted from the message export control section 21 again in step S11, the user terminal 1 returns to the processing in step S6. When the user can reply to the message, the user terminal 1 transmits a reply signal to the reply confirming section 23 (YES in step S6).

(b) Processing for Reply Confirmation Signal “Absence” in Step S7:

Upon receiving the reply confirmation signal “absence” from the reply confirming section 23, the action executing section 24 sends to the user setting storage section 22 a reference request for, of pieces of user setting information stored in the user setting storage section 22, action information stored in correspondence with the user of the user terminal for which no reply confirmation has been done (step S12).

Upon receiving the reference request from the action executing section 24, the user setting storage section 22 extracts the action information that is contained in the reference request and stored in correspondence with the user of the user terminal and sends the action information to the action executing section 24 (step S13). At this time, the user setting storage section 22 receives the reference request from the action executing section 24 and simultaneously confirms the authenticity of the action executing section 24, thereby preventing any illicit access to the user setting information.

Upon receiving the action information from the user setting storage section 22 (step S13), the action executing section 24 executes the action based on the action information set by the user in advance (step S14).

Note that various kinds of actions can be executed by the action executing section 24, and actions that cannot be executed by the user himself/herself include, e.g., mail submission to a desired address, a transaction instruction to a financial institution, and a call to a customer. The contents of an action are not particularly limited as long as it can be electronically executed.

In the above embodiment, the message export timing is determined by the message export control section 21 on the basis of the message export condition sent from the user setting storage section 22. The export timing may also be determined by the user setting storage section 22. In this case, the user setting storage section 22 determines the message export timing on the basis of the stored message export condition and notifies the message export control section 21 of the user terminal address at the determined export timing, and a message is submitted from the message export control section 21 to the user terminal 1.

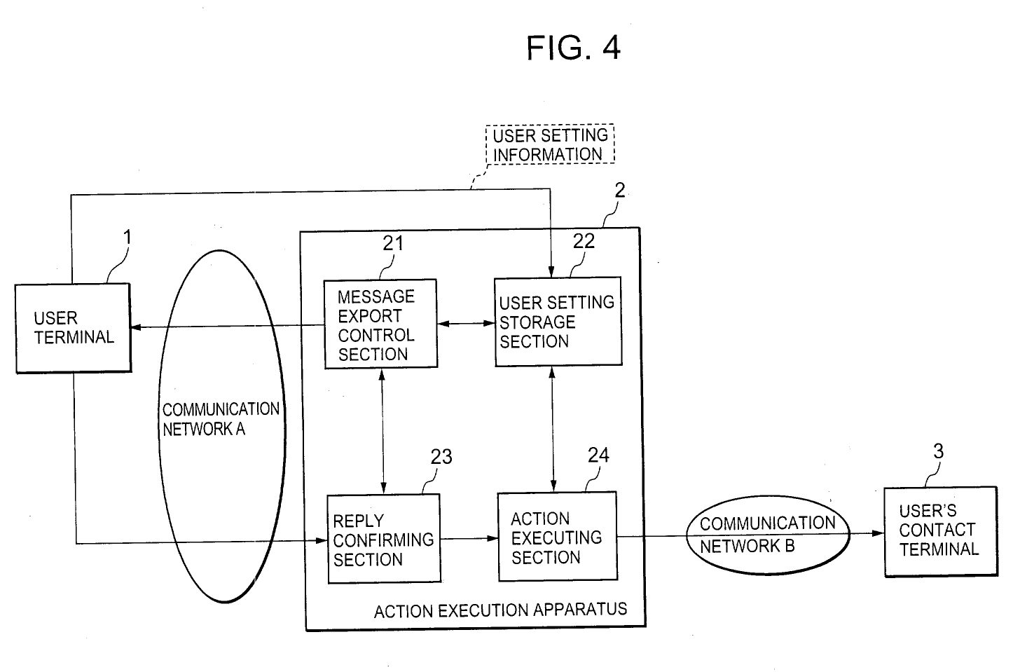

Examples of user setting information will be described next with reference to FIGS. 4 to 6.

(1) First Setting Example of User Setting Information:

In the first setting example shown in FIG. 4, when the user terminal 1 accesses the user setting storage section 22 in the action execution apparatus 2 through the communication network A, the user name (U1), the address (A1) of the user terminal 1, the message export condition (B1), and the action information (C1) are set.

In the first setting example shown in FIG. 4, for example, if an action that should be remembered in the office is presumed, the user sets user setting information in advance from his/her terminal to the action execution apparatus 2. Even if the user is being out when a message is submitted from the message export control section 21 to the user terminal 1, a desired preset action can be executed.

(2) Second Setting Example of User Setting Information:

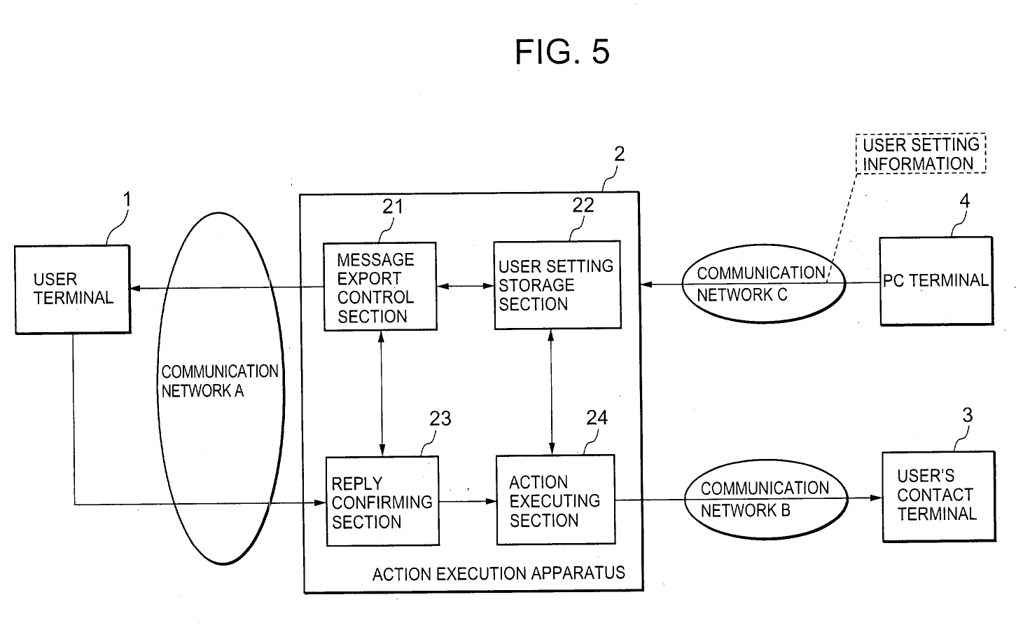

In the second setting example shown in FIG. 5, when a PC terminal 4 that is different from the user terminal 1 accesses the user setting storage section 22 in the action execution apparatus 2 through a communication network C, the user name (U2), the address (A2) of the user terminal 1, the message export condition (B2), and the action information (C2) are set. Note that the communication network C and communication network A or B may be a single communication network or separate communication networks.

In the second setting example shown in FIG. 5, for example, if an action that should be remembered is presumed, the user sets user setting information in advance from the terminal (PC terminal 4) in the office to the action execution apparatus 2. Even if the user is not near the user terminal 1 when a message is submitted from the message export control section 21 to the user terminal 1, a desired preset action can be executed. The installation location of the PC terminal 4 is not limited to the office as far as the PC terminal 4 is different from the user terminal 1 that is set as the message submission destination.

(3) Third Setting Example of User Setting Information:

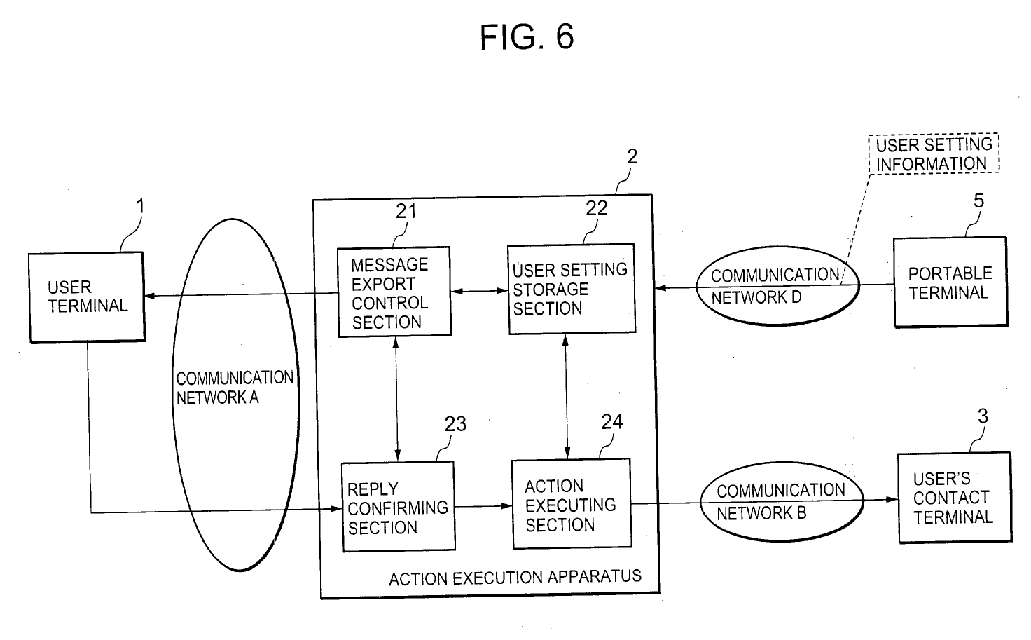

In the third setting example shown in FIG. 6, when user's portable terminal (cellular phone or PDA) 5 accesses the user setting storage section 22 in the action execution apparatus 2 through a mobile communication network D, the user name (Ui), the address (Ai) of the user terminal 1, the message export condition (Bi) and the action information (Ci) are set.

In the third setting example shown in FIG. 6, for example, if an action that should be remembered is presumed, the user sets user setting information in advance from his/her cellular phone to the action execution apparatus 2. Even if the user can transmit no reply signal to a message when the message is submitted from the message export control section 21 to the user terminal 1, a desired preset action can be executed.

As described above, user setting information can be set to the user setting storage section 22 in the action execution apparatus 2 by any setting method.

In the communication system according to the first embodiment of the present invention, the action execution apparatus 2 having functional sections comprising the message export control section 21, user setting storage section 22, reply confirming section 23, and action executing section 24 is implemented. However, the action execution apparatus may be implemented as an action execution server having the same function as described above.

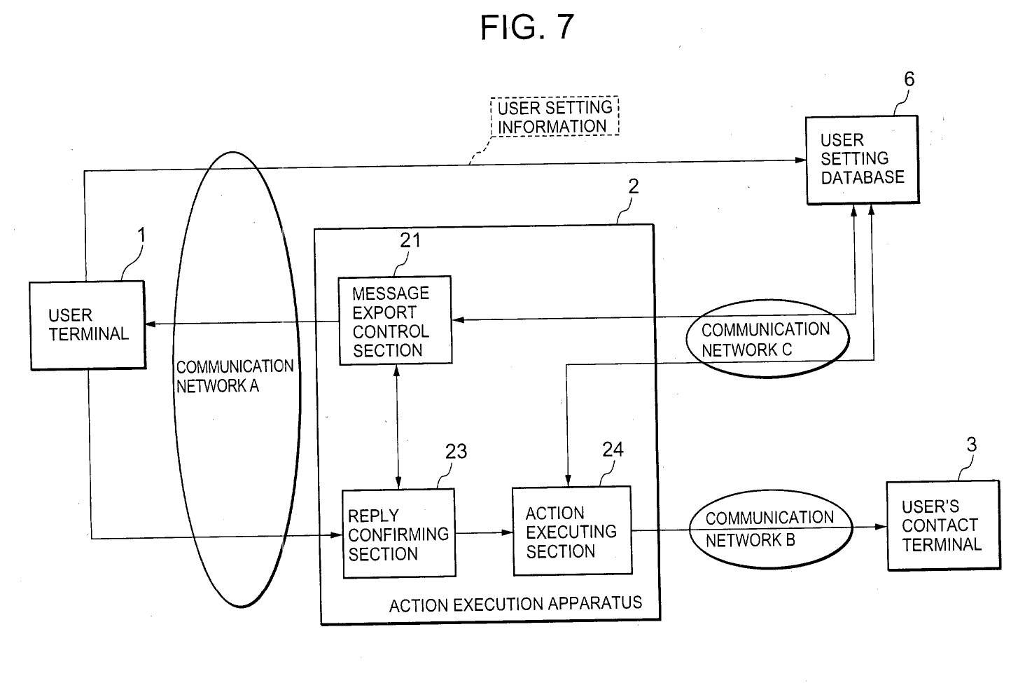

A communication system according to the second embodiment of the present invention will be described next with reference to FIG. 7.

In the communication system of the second embodiment, user setting storage section 22 is not arranged in an action execution apparatus 2, unlike the first embodiment. Instead, the user setting storage section 22 is arranged outside the action execution apparatus 2 as a user setting database 6.

The user setting database 6 is connected to a user terminal 1 through a communication network A and also to the action execution apparatus 2 through a communication network C. The communication networks A and C may be a single communication network or separate communication networks.

With this arrangement, the load on the action execution apparatus 2 can be reduced. In addition, the user setting database 6 can be managed by existing ASP or the like.

User setting information can be set to the user setting database 6 by any one of the above-described methods of the first to third setting examples, i.e., setting from the user terminal 1, setting from a PC terminal 4 different from the user terminal 1, and setting from user's portable terminal 5.

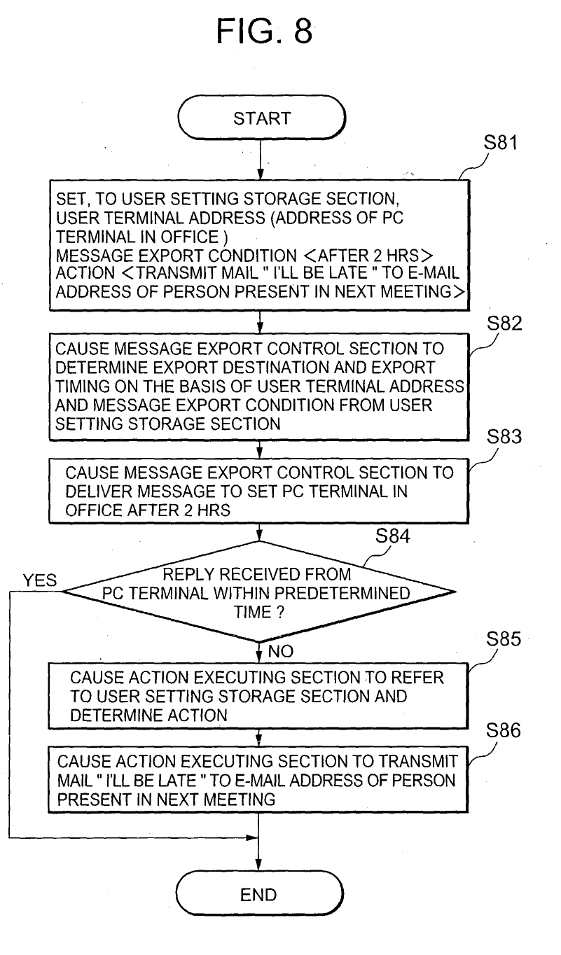

Detailed operations in executing an action in the communication system of the present invention will be described next with reference to the flow charts shown in FIGS. 8 to 11.

First Detailed Operation Example:

The first detailed operation example in the communication system of the present invention shown in FIG. 8 assumes a contact action when a user who is attending a meeting must also attend another meeting. The user sets to the user setting storage section 22 user setting information containing

user terminal address <mail address of PC terminal in office>

message export condition <after 2 hrs from current time>

action <transmit mail “I'll be late” to e-mail address of person present in next meeting>

by one of the above-described first to third setting methods (step S81).

Upon receiving the user setting information from the user setting storage section 22, the message export control section 21 determines the message export destination (PC terminal in the office) and the message export timing (after 2 hrs from the current time) on the basis of the user terminal address and message export condition (step S82) and submits the message to the PC terminal in the office after 2 hrs from the current time (step S83).

When the message is submitted from the message export control section 21, and the user replies to the message at that time, the reply confirming section 23 determines that a reply has been received within a predetermined time (YES in step S84), and the processing is ended.

On the other hand, when the message is submitted from the message export control section 21, and the user cannot reply to the message at that time because he/she is attending a meeting or being out, the reply confirming section 23 determines that no reply has been received from the PC terminal in the office within the predetermined time (NO in step S84) and sends (transmits) a reply confirmation signal “absence” to the action executing section 24.

Upon receiving the reply confirmation signal “absence” from the reply confirming section 23, the action executing section 24 refers to the action information in the user setting information stored in the user setting storage section 22, determines the action to be executed (transmit mail “I'll be late” to the e-mail address of a person present in the next meeting) (step S85), and transmits mail having contents “I'll be late” to the e-mail address of the person present in the next meeting on the basis of the determined contents (step S86).

Second Detailed Operation Example:

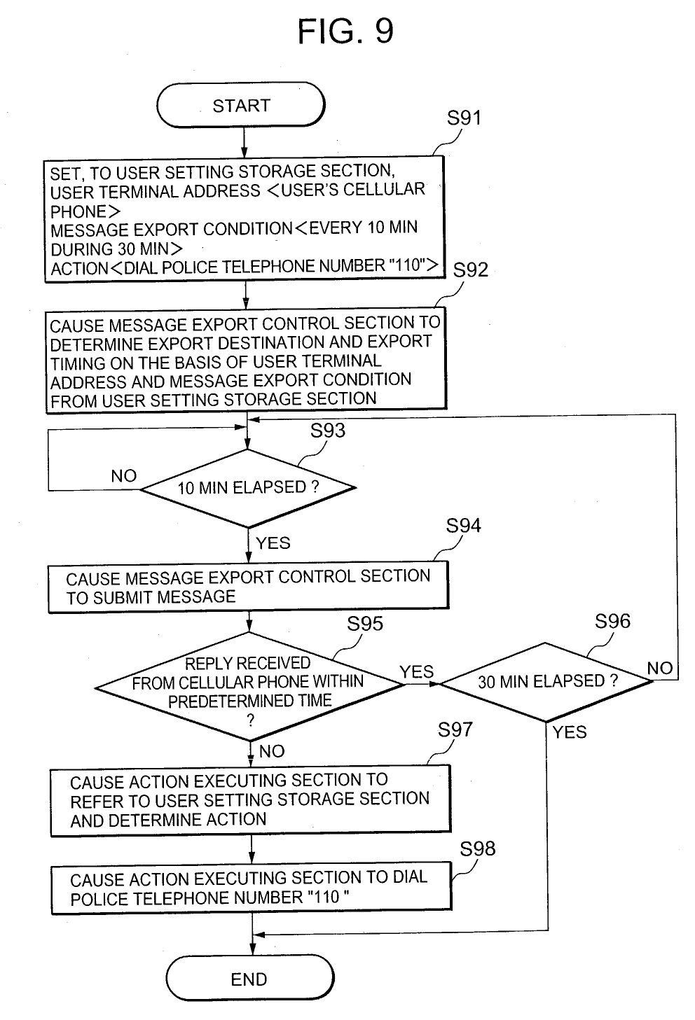

The second detailed operation example shown in FIG. 9 assumes an emergency informing action when a user goes home along from a station late at night. The user sets to the user setting storage section 22 user setting information containing

user terminal address <mail address of user's cellular phone>

message export condition <every 10 min during 30 min from current time>

action <dial police telephone number “110”>

by one of the above-described first to third setting methods (step S91).

Upon receiving the user setting information from the user setting storage section 22, the message export control section 21 determines the message export destination (user's cellular phone) and the message export timing (every 10 min during 30 min from the current time) on the basis of the user terminal address and message export condition (step S92).

The message export control section 21 starts counting 30 min from the current time. Every 10 min (YES in step S93), a message is submitted to the user's user cellular phone (step S94).

When the message is submitted from the message export control section 21, and the user replies to the message at that time (YES in step S95), it is determined whether 30 min has elapsed from the start of counting (step S96). If the time has not elapsed yet (NO in step S96), the processing returns to step S93 to determine again whether 10 min has elapsed. If it is determined in step S96 that 30 min has elapsed from the start of counting (YES in step S96), the processing is ended.

On the other hand, when no reply has been received from the cellular phone within the predetermined time (NO in step S95), the reply confirming section 23 determines that no reply has been received from the cellular phone within the predetermined time (NO in step S95) and sends (transmits) a reply confirmation signal “absence” to the action executing section 24.

Upon receiving the reply confirmation signal “absence” from the reply confirming section 23, the action executing section 24 refers to the action information in the user setting information stored in the user setting storage section 22, determines the action to be executed (dial the police telephone number “110”) (step S97), and dials the police telephone number “110” on the basis of the determined contents (step S98).

In the second detailed operation example, the message is submitted at least three times. For example, if no reply from the user terminal to the first message is confirmed, a voice message “I'm at the nearest station” may be submitted to the stationary telephone in home (action 1). If no reply from the user terminal to the second message is confirmed, mail “I'm at the nearest station” may be transmitted to the cellular phone of one of the family (action 2). If no reply from the user terminal to the third message is confirmed, a message “I may get in trouble or be involved in an accident on my way home” may be submitted to a terminal in the police by dialing “110” (action 3).

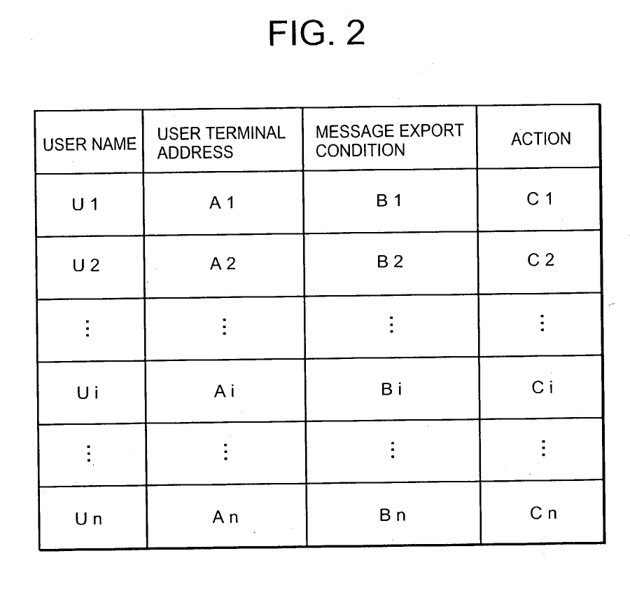

In this way, a plurality of action phases may be set in accordance with the number of times of message submission. This can be realized by setting the individual setting contents of the actions C1 to Cn shown in FIG. 2 in correspondence with the number of times of message submission when the user sets the user setting information.

Third Detailed Operation Example:

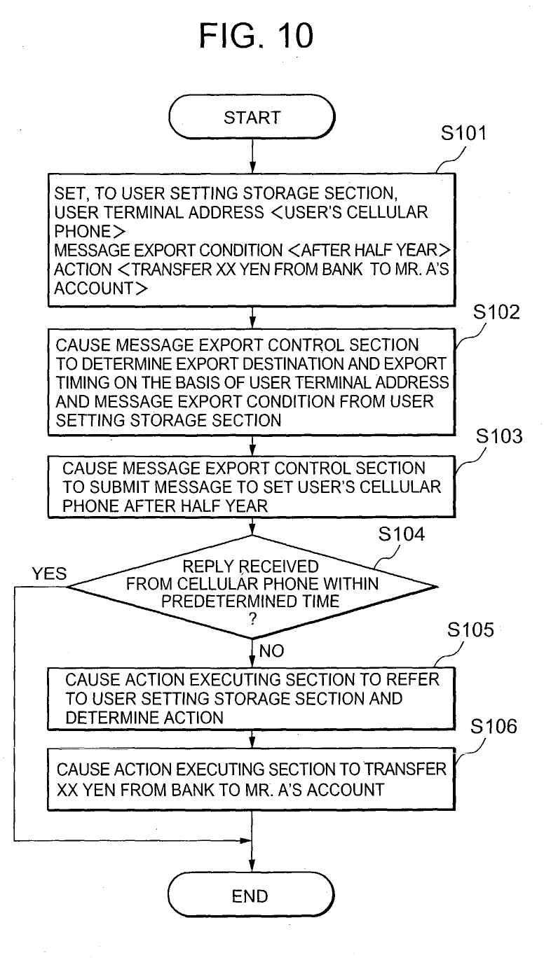

The third detailed operation example shown in FIG. 10 assumes a testamentary informing action by, e.g., an aged person who lives alone. The user sets to the user setting storage section 22 user setting information containing

user terminal address <user's cellular phone>

message export condition <after half year from current time>

action <transfer XX yen from bank to Mr. A's account>

by one of the above-described first to third setting methods (step S101).

Upon receiving the user setting information from the user setting storage section 22, the message export control section 21 determines the message export destination (user's cellular phone) and the message export timing (after half year from the current time) on the basis of the user terminal address and message export condition (step S102). After half year from the current time, the message export control section 21 exports a message to the user's cellular phone (step S103).

When the message is submitted from the message export control section 21, and the user replies to the message at that time, the reply confirming section 23 determines that a reply has been received within a predetermined time (YES in step S104), and the processing is ended.

On the other hand, when the message is submitted from the message export control section 21, and the user has been ill or dead and therefore cannot reply to the message at that time, the reply confirming section 23 determines after the elapse of a predetermined time that no reply has been received from the user's cellular phone (NO in step S104), and sends (transmits) a reply confirmation signal “absence” to the action executing section 24.

Upon receiving the reply confirmation signal “absence” from the reply confirming section 23, the action executing section 24 refers to the action information in the user setting information stored in the user setting storage section 22, determines the action to be executed (transfer XX yen from the bank to Mr. A's account) (step S105), and executes the transaction “transfer XX yen from the bank to Mr. A's account” on the basis of the determined contents (step S106).

In a case like the third detailed operation example, a special contract with the bank or legal procedures for validating the transaction are necessary. In addition, authentication processing at the access time must be strictly performed. In addition to the strict authentication processing, if important data (action information or the like) is to be actually transmitted to the communication network, the data is preferably transmitted as encrypted data, or VPI (Virtual Privative Network) having an encrypted communication path is preferably used from the viewpoint of security.

Fourth Detailed Operation Example:

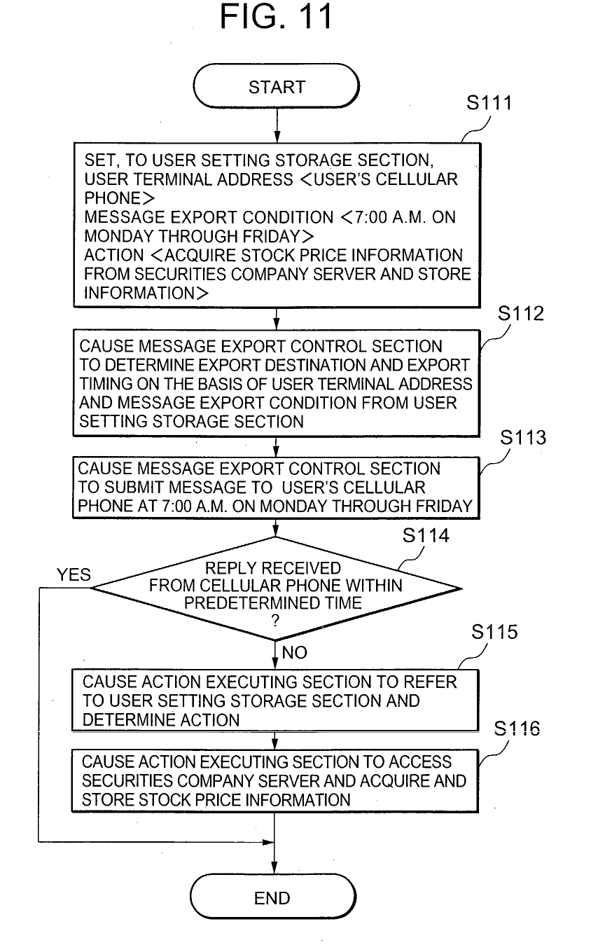

The fourth detailed operation example shown in FIG. 11 assumes a habitual behavioral action in which an office worker checks stock prices every morning. The user sets to the user setting storage section 22 user setting information containing

user terminal address <user's cellular phone>

message export condition <7:00 a.m. on Monday through Friday>

action <acquire stock price information from securities company server and store the information>

by one of the above-described first to third setting methods (step S111).

Upon receiving the user setting information from the user setting storage section 22, the message export control section 21 determines the message export destination (user's cellular phone) and the message export timing (every morning at 7:00 a.m. on Monday through Friday) on the basis of the user terminal address and message export condition (step S112). Every morning at 7:00 a.m. on Monday through Friday, the message export control section 21 exports a message to the user's cellular phone (step S113).

When the message is submitted from the message export control section 21, and the user replies to the message at that time, the reply confirming section 23 determines that a reply has been received within a predetermined time (YES in step S114), and the processing is ended.

On the other hand, when the message is submitted from the message export control section 21, and the user is still sleeping and therefore cannot reply to the message at that time, the reply confirming section 23 determines after the elapse of a predetermined time that no reply has been received from the cellular phone (NO in step S114), and sends (transmits) a reply confirmation signal “absence” to the action executing section 24.

Upon receiving the reply confirmation signal “absence” from the reply confirming section 23, the action executing section 24 refers to the action information in the user setting information stored in the user setting storage section 22, determines the action to be executed (acquire stock price information from a securities company server and store the information) (step S115), and executes the processing “acquire stock price information from a securities company server and store the information” on the basis of the determined contents (step S116).

In a case like the fourth detailed operation example, if the user cannot reply to the message exported from the message export control section 21, the action executing section 24 can access the securities company server to acquire stock price information and store the acquired information. In addition, e-mail to which the thus acquired stock price information may be delivered to a contact terminal (user's cellular phone or the like) designated by the user.

The above-described embodiments and detailed operation examples are the preferable embodiments and detailed operation examples of the present invention. Various changes and modifications can be made within the spirit and scope of the invention.

For example, the above-described embodiments are implemented by the system comprising the user terminal and action execution apparatus (or server). However, the functional blocks of the action execution apparatus may be built as a system capable of distributed processing. In this case, a control section (CPU), ROM, RAM, communication function, and the like are prepared as components for realizing distributed processing for each functional block.

What is claimed is:

1. A communication system comprising:
message export means for exporting a message to a user terminal through a communication network on the basis of a preset export condition;
reply confirming means for receiving from the user terminal through the communication network a reply to the message exported by said message export means, and confirming the reply; and
action executing means for executing a preset action when said reply confirming means confirms no reply.

2. A system according to claim 1, wherein
said system further comprises user setting information storage means for storing user setting information containing an address of the user terminal, the export condition, and the action, and
said message export means and said action executing means execute respective functions on the basis of the user setting information stored in said user setting information storage means.

3. A system according to claim 2, wherein said action executing means executes the action stored in said user setting information storage means or transmits information that causes execution of the action to a contact terminal connected through the communication network.

4. A system according to claim 1, wherein said reply confirming means has a timer which counts a time elapsed from message export by said message export means, and when the elapsed time counted by the timer has reached predetermined time, determines that no reply is received from the user terminal.

5. A system according to claim 1, wherein the action is submission to a contact terminal of the user.

6. A system according to claim 2, wherein the user setting information is arbitrarily set from the user terminal through the communication network.

7. A system according to claim 2, wherein the user setting information is arbitrarily set from a terminal apparatus which is connected through the communication network and is different from the user terminal.

8. A system according to claim 2, wherein the user setting information is arbitrarily set from a portable terminal connected through a mobile communication network.

9. A communication system comprising an action execution apparatus,
said action execution apparatus comprising:
a message export section which exports a message to a user terminal through a communication network on the basis of a preset export condition;
a reply confirming section which receives from the user terminal through the communication network a reply to he message exported by said message export section, and confirms the reply; and
an action executing section which executes a preset action when said reply confirming section confirms no reply,
wherein the user terminal and said action execution apparatus are connected through the communication network.

10. A system according to claim 9, wherein
said action execution apparatus further comprises a user setting information storage section which stores user setting information containing an address of the user terminal, the export condition, and the action, and
said message export section and said action executing section execute respective functions on the basis of the user setting information stored in said user setting information storage section.

11. A system according to claim 10, wherein said action executing section executes the action stored in said user setting information storage section or transmits information that causes execution of the action to a contact terminal connected through the communication network.

12. A system according to claim 9, wherein said reply confirming section has a timer which counts a time elapsed from message export by said message export section, and when the elapsed time counted by the timer has reached predetermined time, determines that no reply is received from the user terminal.

13. A system according to claim 9, wherein the action is submission to a contact terminal of the user.

14. A system according to claim 10, wherein the user setting information is arbitrarily set from the user terminal through the communication network.

15. A system according to claim 10, wherein the user setting information is arbitrarily set from a terminal apparatus which is connected through the communication network and is different from the user terminal.

16. A system according to claim 10, wherein the user setting information is arbitrarily set from a portable terminal connected through a mobile communication network.

17. A communication method comprising:
the message export step of exporting a message to a user terminal through a communication network on the basis of a preset export condition;
the reply confirming step of receiving from the user terminal through the communication network a reply to the message exported in the message export step, and confirming the reply; and
the action executing step of executing a preset action when no reply is confirmed in the reply confirming step.

18. A method according to claim 17, wherein
the method further comprises the user setting information storage step of storing user setting information containing an address of the user terminal, the export condition, and the action, and
in the message export step and the action executing step, respective processes are executed on the basis of the user setting information stored in the user setting information storage step.

19. A method according to claim 18, wherein in the action executing step, the action stored in the user setting information storage step is executed, or information that causes execution of the action is transmitted to a contact terminal connected through the communication network.

20. A method according to claim 17, wherein in the reply confirming step, a time elapsed from message export in the message export step is counted, and when the elapsed time has reached predetermined time, it is determined that no reply is received from the user terminal.

21. A method according to claim 17, wherein the action is submission to a contact terminal of the user.

22. A method according to claim 18, wherein the user setting information is arbitrarily set from the user terminal through the communication network.

23. A method according to claim 18, wherein the user setting information is arbitrarily set from a terminal apparatus which is connected through the communication network and is different from the user terminal.

24. A method according to claim 18, wherein the user setting information is arbitrarily set from a portable terminal connected through a mobile communication network.

25. A communication method in a communication system in which a user terminal is connected to an action execution apparatus through a communication network, comprising causing the action execution apparatus to execute:
the message export step of exporting a message to the user terminal through the communication network on the basis of a preset export condition;
the reply confirming step of receiving from the user terminal through the communication network a reply to the message exported in the message export step, and confirming the reply; and
the action executing step of executing a preset action when no reply is confirmed in the reply confirming step.

26. A method according to claim 25, wherein
the action execution apparatus further executes the user setting information storage step of storing user setting information containing an address of the user terminal, the export condition, and the action, and
in the message export step and the action executing step, respective processes are executed on the basis of the user setting information stored in the user setting information storage step.

27. A method according to claim 26, wherein in the action executing step, the action stored in the user setting information storage step is executed, or information that causes execution of the action is transmitted to a contact terminal connected through the communication network.

28. A method according to claim 25, wherein in the reply confirming step, a time elapsed from message export in the message export step is counted, and when the elapsed time has reached predetermined time, it is determined that no reply is received from the user terminal.

29. A method according to claim 25, wherein the action is submission to a contact terminal of the user.

30. A method according to claim 26, wherein the user setting information is arbitrarily set from the user terminal through the communication network.

31. A method according to claim 26, wherein the user setting information is arbitrarily set from a terminal apparatus which is connected through the communication network and is different from the user terminal.

32. A method according to claim 26, wherein the user setting information is arbitrarily set from a portable terminal connected through a mobile communication network.

33. An action execution apparatus connected to a user terminal through a communication network, comprising:
message export means for exporting a message to the user terminal through the communication network on the basis of a preset export condition;
reply confirming means for receiving from the user terminal through the communication network a reply to the message exported by said message export means, and confirming the reply; and
action executing means for executing a preset action when said reply confirming means confirms no reply.

34. An apparatus according to claim 33, wherein
said apparatus further comprises user setting information storage means for storing user setting information containing an address of the user terminal, the export condition, and the action, and
said message export means and said action executing means execute respective functions on the basis of the user setting information stored in said user setting information storage means.

35. An apparatus according to claim 34, wherein said action executing means executes the action stored in said user setting information storage means or transmits information that causes execution of the action to a contact terminal connected through the communication network.

36. An apparatus according to claim 33, wherein said reply confirming means has a timer which counts a time elapsed from message export by said message export means, and when the elapsed time counted by the timer has reached predetermined time, determines that no reply is received from the user terminal.

37. An apparatus according to claim 33, wherein the action is submission to a contact terminal of the user.

38. An apparatus according to claim 33, wherein the user setting information is arbitrarily set from the user terminal through the communication network.

39. An apparatus according to claim 33, wherein the user setting information is arbitrarily set from a terminal apparatus which is connected through the communication network and is different from the user terminal.

40. An apparatus according to claim 33, wherein the user setting information is arbitrarily set from a portable terminal connected through a mobile communication network.

41. A program used in a communication system formed by connecting a user terminal to an action execution apparatus through a communication network, said program causing the action execution apparatus to execute:
a message export process for exporting a message to the user terminal through the communication network on the basis of a preset export condition;
a reply confirming process for receiving from the user terminal through the communication network a reply to the message exported by the message export process, and confirming the reply; and
an action executing process for executing a preset action when no reply is confirmed by the reply confirming process.

42. A program according to claim 41, wherein
the action execution apparatus further executes a user setting information storage process for storing user setting information containing an address of the user terminal, the export condition, and the action, and
in the message export process and the action executing process, respective processes are executed on the basis of the user setting information stored by the user setting information storage process.

43. A program according to claim 42, wherein in the action executing process, the action stored by the user setting information storage process is executed, or information that causes execution of the action is transmitted to a contact terminal connected through the communication network.

44. A program according to claim 41, wherein in the reply confirming process, a time elapsed from message export by the message export process is counted, and when the elapsed time has reached predetermined time, it is determined that no reply is received from the user terminal.

45. A program according to claim 41, wherein the action is submission to a contact terminal of the user.

46. A program according to claim 42, wherein the user setting information is arbitrarily set from the user terminal through the communication network.

47. A program according to claim 42, wherein the user setting information is arbitrarily set from a terminal apparatus which is connected through the communication network and is different from the user terminal.

48. A program according to claim 42, wherein the user setting information is arbitrarily set from a portable terminal connected through a mobile communication network.
